(19) United States
(12) Patent Application Publication
(10) Pub. No.: US 2009/0049214 A1
(43) Pub. Date: Feb. 19, 2009

(54) GRAPHICS CARD TEST METHOD

(75) Inventors: AI-MIN CHEN, Shenzhen (CN); XIAO-LIN GAN, Shenzhen (CN); YU-KUANG HO, Tu-Cheng (TW); PENG LI, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/967,126

(22) Filed: Dec. 29, 2007

(30) Foreign Application Priority Data
Aug. 14, 2007 (CN) 200710201361.2

(51) Int. Cl. G06F 13/40

(52) U.S. Cl. 710/104

(57) ABSTRACT

A method for testing graphics cards is provided. The method utilizes a principle that when an operating system operates under a kernel layer, a CPU of the computer has privileges to execute any instructions, thus, able to perform privileged functions of a graphics card, thereby testing hardware acceleration functions of the graphics card. Utilizing the above method can test self-owned brand graphics cards before the GPU manufactured provides a formal graphics card driver of the graphics cards, and avoids abnormal situations resulting in bad communication between a graphics card test program and an informal graphics card driver of the graphics cards.

### BACKGROUND OF THE INVENTION

1. Field of the Invention

The present invention relates to methods for testing add-on cards of computers, and more particularly, to a graphics card test method.

2. Description of Related Art

At present, real-time three-dimensional (3D) graphics become common in computer games, which lead to an increasing demand for 3D graphics cards. In a graphics industry chain, manufacturers provide graphics chips, be known as graphic processing unit (GPU), to downstream graphics card manufacturers, then multiple independent graphics cards with self-owned brands are put into market by the graphics card manufacturers.

Before putting into market, the graphics cards need to be tested for checking their operability. FIG. 1 is a flowchart of a traditional method for testing graphics card. As shown in FIG. 2, the traditional method for testing graphics card includes steps of: installing a graphics card to be checked onto a motherboard of a computer (step S10); powering on the computer (step S12); installing a graphics card test program (such as 3DMark06) and a graphics card driver under an operating system (such as Windows XP) of the computer, and setting a shortcut of the graphics card test program on a desktop of the operating system (step S14); clicking the shortcut to open the graphics card test program, and setting test parameters on an interface provided by the graphics card test program (step S16); setting a test duration of the graphics card test program, such as 12 hours (step S18); saving above settings and enabling the graphics card test program to run based on the above settings (step S20).

If the operating system and the graphics card test program run normally, and no mosaics occurs on a displayer of the computer during the test process, it is determined that the hardware design of the graphics card is qualified.

However, following abnormal situations often occur by utilizing the above method: the computer system halts, the graphics card test program exits (not reach the test duration), or the displayer of the computer becomes blank. Why the above-mentioned abnormal situations occur? Who brings up the above-mentioned abnormal situations? Is the hardware design of the graphics card unqualified, or the software environment unsuitable? If the test engineer restarts the computer, the operating system often indicates that “Win32 DLL file lost”. “DLL” is the shortened form of dynamical link library.

In addition, if the test engineer runs a diagnosis program provided by the GPU manufacturer under a disk operation system (DOS) operating system, the hardware design of the graphics card accords with requirements of a reference design of graphics cards. The reference design of graphics cards is a printed circuit board (PCB) design, which is optimal for a mass of production of the graphics cards and developed by the GPU manufacturer. Accordingly, it can be concluded that the software environment leads to the above-mentioned abnormal situations.

After repeating experimenting, test engineers find that if not test special effects (such as anti-aliasing and texture filtering) of the graphics card, complex graphics operation functions of the graphics card are not activated, the graphics card test program in a user layer of the operating system can successfully request service from a kernel layer of the operating system via a DLL, and execute functions provided by a Win32 application programming interface (hereinafter “Win32API”). As a result, the graphics driver in the kernel layer may successfully response service requests from the user layer.

Comparatively, if the special effects of the graphics card are activated by opening the special effects of 3DMark, the graphics card test program 40 needs more DLLs as mediums to call the Win32API. At the primary design stage before graphics cards developed by the GPU manufacturer are put into market, what considered first by the GPU manufacturer is to ensure work cooperation between the graphics driver and the graphics card in the kernel layer of the operating system, thereby ensuring common operations of the graphics card first. However, the work cooperation (such as interrupts, conflicts, and traps) between the graphics driver and user applications (such as the graphics card test program and the DLLs) in the user layer may have problems at the primary design stage, such as the Win32API may not reply call of the DLLs, thus the DLLs would maintain a waiting status until the system indicates that “Win32 DLL file lost”.

Causations of the abnormal situations occurred during the test process are acquainted, however, traditional solution of the abnormal situations depends on the GPU manufacturer to provide updated formal graphics driver. When the GPU manufacturer issues the updated formal graphics driver, the graphics cards developed by the GPU manufacturer have been put into the market, however, test of the self-owned brand graphics cards have not yet completed, which prolongs development period of the self-owned brand graphics cards and weakens competitive powers of the self-owned brand graphics cards.

What is needed, therefore, is a new method for test graphics cards, which can test self-owned brand graphics cards before the GPU manufactured provides a formal graphics card driver of the graphics cards, and avoids the abnormal situations occurred when utilizing the informal graphics card driver.

### SUMMARY OF THE INVENTION

An embodiment provides a preferred method for testing graphics cards. The method prefers running a graphics card test program to test a graphics card in a computer under a kernel layer of an operating system. The method includes steps of: (A) installing the graphics card onto a motherboard of the computer; (B) powering on the computer; (C) installing the graphics card test program and a graphics card driver under the operating system of the computer; (D) selecting a system control panel from a start menu bar on a desktop of the operating system; (E) opening a GPU control panel in the system control panel; (F) setting test parameters on an interface provided by the GPU control panel; (G) setting a test duration; and (H) saving above settings and enabling the graphics card test program to run based on the test parameters within the test duration.

Other objects, advantages and novel features of the present invention will be drawn from the following detailed description of the preferred embodiment and preferred method of the present invention with the attached drawings.

### BRIEF DESCRIPTION OF THE DRAWINGS

FIG. 1 is a flowchart of a traditional method for testing graphics card;

FIG. 2 is an illustration of a system environment incorporating a graphics card test method; and

FIG. 3 is a flowchart of the graphics card test method in accordance with a preferred embodiment.

### DETAILED DESCRIPTION OF THE PREFERRED EMBODIMENT

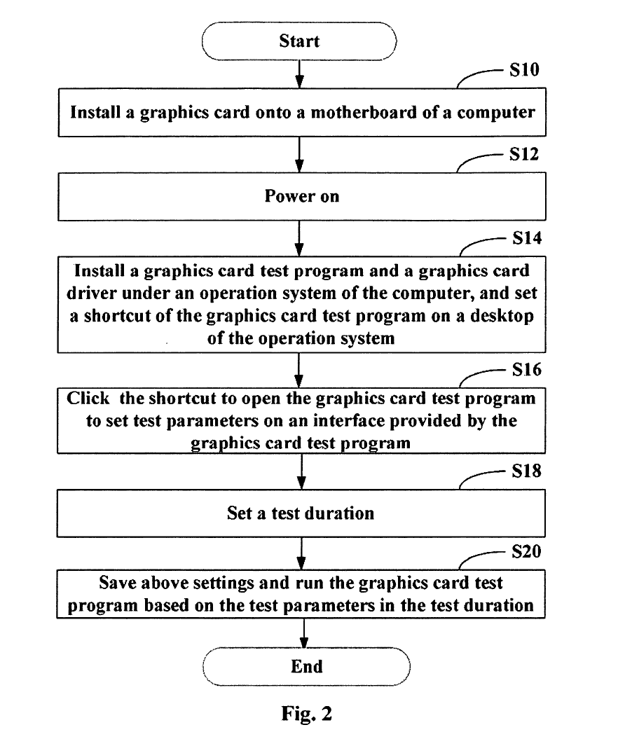

FIG. 2 is an illustration of a system environment incorporating a graphics card test method. The system environment mainly includes a computer, which has a hardware layer and a software layer. The hardware layer typically includes a motherboard 10 and a graphics card 20 installed on the motherboard 10. The software layer typically includes an operating system 30. The operating system 30 has a user layer and a kernel layer. User applications, such as a graphics card test program 40 and dynamical link library (DLLs) 50, run in the user layer, while system service applications, such as Win32API 60, and third party device drivers, such as a graphics card driver 70, run in the kernel layer.

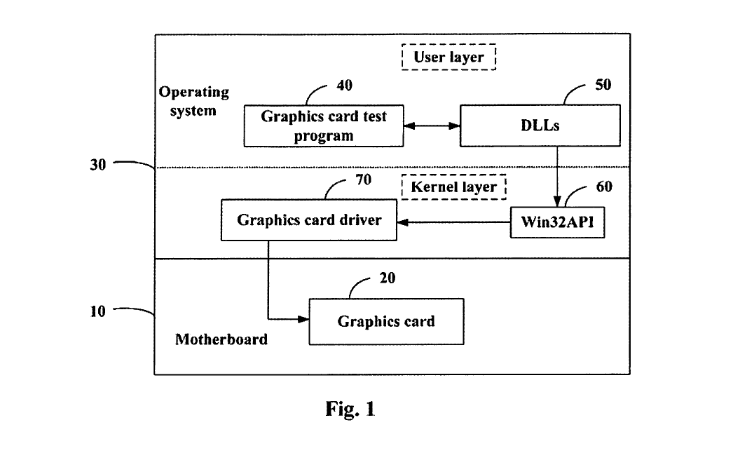

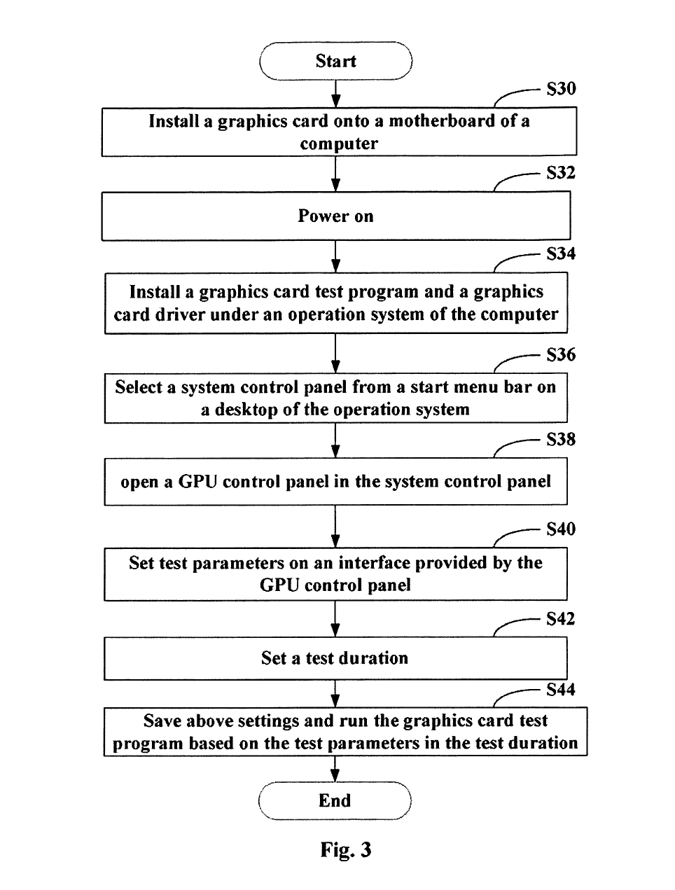

FIG. 3 is a flowchart of a graphics card test method in accordance with a preferred embodiment. The test method utilizes a principle that when the operating system 30 operates under the kernel layer, a central process unit (CPU) (not shown in FIG. 1) of the computer has privileges to execute any instructions, thus, able to perform privileged functions of the graphics card 20, thereby testing hardware acceleration functions of the graphics card 20.

In step S30, installing the graphics card 20 onto the motherboard 10 of the computer. In step S32, the computer is powered on. In step S34, installing the graphics card test program 40 (such as 3DMark06) and the graphics card driver 70 under the operating system 30 (such as Windows XP) of the computer.

In step S36, selecting a system control panel from a start menu bar on a desktop of the operating system 30. In step S38, opening a GPU control panel in the system control pane, that is to say, entering the kernel layer of the operating system 30. In step S40, setting test parameters on an interface provided by the GPU control panel. The test parameters typically include kernel frequency, memory frequency, memory brand width, and image quality parameters of the graphics card 20. The image quality parameters may include special function (effects) such as anti-aliasing and texture filtering, i.e. bi-linear, tri-linear, or anisotropic texture filtering.

In step S42, setting a test duration, in other words, a length of time that the graphics card test program 40 would run continuously, such as 12 hours. In step S44, saving above settings and enabling/running the graphics card test program 40 with the test parameters within the test duration.

As the CPU of the computer has the privilege of executing any instructions in the kernel layer of the operating system 30, the graphics card test program 40 can successfully call the Win32API 60 via the DLLs 50. The Win32API 60 transmits the test parameters to the graphics driver 70 after called from the graphics card test program 40. The graphics driver 70 drives the graphics card 20 to perform its functions according to the test parameters, and return corresponding results to the graphics card test program 40.

The test method can be used for validating all kinds of graphics cards and display chips in computers, or any other add-on cards of computers.

Although the present invention has been specifically described on the basis of a preferred embodiment and preferred method, the invention is not to be construed as being limited thereto. Various changes or modifications may be made to the embodiment and method without departing from the scope and spirit of the invention.

What is claimed is:

1. A graphics card test method, which utilizes a graphics card test program to test a graphics card in a kernel layer of an operating system, comprising:
installing the graphics card onto a motherboard of a computer;
powering on the computer;
installing the graphics card test program and a graphics card driver under the operating system of the computer;
selecting a system control panel from a start menu bar on a desktop of the operating system;
opening a GPU control panel in the system control panel;
setting test parameters on an interface provided by the GPU control panel;
setting a test duration for controlling the graphics card test program to run continually; and
saving the test parameters and the test duration, and enabling the graphics card test program to run in the test duration based on the above test parameters.

2. The graphics card test method as claimed in claim 1, wherein the test parameters comprise kernel frequency, memory frequency, memory brand width, and image quality parameters of the graphics card.

3. The graphics card test method as claimed in claim 2, wherein the image quality parameters comprises antialiasing and texture filtering.
